(19) United States
(12) Patent Application Publication
(10) Pub. No.: US 2025/0069522 A1
(43) Pub. Date: Feb. 27, 2025

(54) METHOD AND SYSTEM FOR CHILDREN'S MEAL MENU CHOICE

(71) Applicant: Jacqueline Ann Jansky, Topsfield, MA (US)

(72) Inventor: Jacqueline Ann Jansky, Topsfield, MA (US)

(21) Appl. No.: 18/810,925

(22) Filed: Aug. 21, 2024

Related U.S. Application Data
(60) Provisional application No. 63/628,779, filed on Aug. 21, 2023.

(51) Int. Cl. G09B 19/00; B42D 15/04

(52) U.S. Cl. CPC G09B 19/0092; B42D 15/045

(57) ABSTRACT

The invention is a method that simplifies mealtime with children by allowing them to choose their own meals from a binder of categorized food options. The binder is divided into sections by food group—dairy, protein, fruit, grain, and vegetables—each containing food cards representing items available to a caregiver. The child selects one food card from each section to assemble a balanced meal and attaches them to a menu page. This process empowers the child to make their own choices, fostering independence while learning about balanced eating. Caregivers benefit from reduced meal conflicts and can rotate food options to introduce new foods gradually. This method also reduces food waste by allowing the child to choose items they are more likely to eat and enables caregivers to accommodate changing preferences and dietary needs, creating a more enjoyable and cooperative mealtime experience for all involved.

### CROSS-REFERENCE TO RELATED APPLICATION

This application claims the benefit of and priority to U.S. Provisional Patent Application No. 63/628,779, filed Aug. 21, 2023, the contents of which are incorporated herein by reference.

### FIELD OF THE INVENTION

This invention relates to a method and system which allows children to choose a meal from a binder of food options requiring the child to pick one food item from each of the five major food groups.

### BACKGROUND OF INVENTION

Meal menus exist which allow children to choose the full meal they want. These full meal choices often present an overwhelming combination of flavors, textures, and foods, making it difficult for children to choose. Many children may prefer to have the independent to select foods from different food groups instead of being constrained to a pre-selected full meal options. This desire stems from the natural inclination of children to explore their preferences gradually.

Choosing individual foods from each food group allows a child's taste buds to develop more slowly, enabling them to adjust to new foods and food combinations. It provides a more manageable and less overwhelming experience, where children can begin to understand the different flavors and textures associated with each food group. For example, a child may be more willing to try a vegetable or a protein when it is presented as a standalone option rather than being mixed into a complex dish. This can help them build a more positive relationship with different types of food over time.

Additionally, when children can select individual foods, caregivers can more easily guide them toward a more balanced diet. By ensuring that each food group is represented in the meal, children can receive the necessary nutrients without the pressure of eating a full meal they may not enjoy. This method also fosters independence, as children feel a sense of control over what they are eating, which can lead to a more enthusiastic approach to mealtime.

Unfortunately, existing menus often fail to categorize foods by group and, as a result, may offer unbalanced meal options. These pre-set meal choices may not include all necessary food groups, potentially leading to nutritional gaps. For example, a meal option might lack sufficient vegetables or include an excess of carbohydrates while skimping on proteins. Such imbalances could contribute to poor eating habits if they become a regular part of a child's diet.

Another challenge posed by full meal choices is that they can introduce combinations of flavors and textures that children find unappealing. For a child who prefers simplicity, this can discourage them from trying new foods altogether. For instance, a meal might combine a protein with a sauce or seasoning that the child does not like, making it difficult for them to enjoy even the parts of the meal they would otherwise have eaten. When forced to consume a dish in its entirety, children may push away from trying new foods rather than engaging with them.

The lack of individualized food choice on existing menus also presents challenges for children with specific dietary needs or preferences. Some children may have food allergies, sensitivities, or preferences that require customization, which is not easily accommodated by pre-designed meal options.

In contract, since the subject method and system categorizes food by group and children can choose individual items, they are more likely to engage with a wider variety of foods. This approach can help mitigate the fear of trying something new since the child has the ability to select items based on their comfort level. Over time, as children become more accustomed to the foods they initially enjoy, they may be more willing to explore new options within each food group, further diversifying their diet.

Allowing children to choose individual food components ensures that their specific needs are met without unnecessary complications or risks.

Moreover, selecting individual foods provides an educational opportunity. Children can learn about different food groups and the importance of balance in their meals. This awareness fosters a lifelong understanding of healthy eating habits and equips them with the knowledge to make better food choices as they grow older. Parents can use this system to teach children about the roles of proteins, vegetables, grains, and dairy in maintaining a balanced diet, instilling values that will benefit them for life.

Individualized food group choices can also reduce food waste. When children are given the freedom to pick foods they like, they are more likely to eat everything in the meal.

In summary, the subject system and method allows children to pick individual food groups rather than full meal choices so they can better develop taste and balance nutrition balance. This system and method encourages exploration, fosters independence, reduces food waste, and ensures that all dietary needs are met.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A method for facilitating meal selection by a child, comprising the steps of: providing a plurality of food cards, each food card corresponding to a food item and categorized by food group, the food groups comprising dairy, protein, fruit, grain, and vegetable; assembling the food cards into a binder, the binder having separate sections for each food group; enabling a child to select one food card from each section of the binder, the selected food cards representing the child's choice for a meal comprising at least one food item from each food group; providing a menu page, the menu page having distinct sections corresponding to each food group, wherein the child attaches the selected food card to the corresponding section of the menu page using a hook and loop fastening system; and receiving the completed menu page from the child and preparing a meal for the child based on the food items represented by the selected food cards.

A system for facilitating meal selection by a child, comprising: a plurality of food cards, each food card corresponding to a specific food item and categorized by food group, wherein the food groups comprise dairy, protein, fruit, grain, and vegetable; a binder configured to hold the food cards, the binder having multiple sections, each section dedicated to a specific food group; a menu page configured to allow the child to attach a selected food card from each food group section to the corresponding section of the menu page, wherein the menu page comprises distinct areas for each food group and includes a hook and loop fastening system for attaching the selected food cards; wherein the child selects one food card from each section of the binder, attaches the selected food cards to the corresponding areas of the menu page, and the selected food cards on the menu page are used by the caregiver to prepare a meal for the child based on the food items represented by the food cards.

A method for facilitating meal planning and selection by a child, comprising the steps of: providing a collection of visual food cards, each card associated with a food item and organized by food group, including dairy, protein, fruit, grain, and vegetable categories; organizing the food cards within a structured display system, such as a binder, with dedicated sections for each food group; allowing the child to review and select one food card from each section to assemble a meal that includes at least one food from each food group; presenting a meal template with sections corresponding to each food group, where the child places the selected food cards in the relevant sections using a secure attachment method; and creating a meal for the child based on the food items depicted on the selected food cards.

A method for teaching children balanced meal selection, comprising the steps of: generating a set of food selection cards, each card representing a food item within the categories of dairy, protein, fruit, grain, and vegetable; organizing the selection cards into a categorized system, where each category corresponds to a food group and is physically separated; guiding the child to pick one card from each category to construct a balanced meal; utilizing a meal planning page divided into segments for each food group, where the child attaches the chosen cards to the appropriate segment using a temporary fastening system; and executing meal preparation based on the selections made by the child.

A method of engaging children in meal planning, comprising the steps of: providing a plurality of food option cards, each representing a food item and grouped into distinct food groups: dairy, protein, fruit, grain, and vegetable; arranging the food option cards within an interactive selection tool, including dedicated sections for each food group; prompting the child to select a card from each section, ensuring the meal includes items from all food groups; displaying a meal assembly page with predefined areas for each food group, where the child attaches the selected food cards; and preparing the selected foods according to the items represented on the attached cards.

A method for enabling a child to independently choose a balanced meal, comprising the steps of: preparing a set of food selection cards, each linked to a specific food item and categorized by food group, with groups for dairy, protein, fruit, grain, and vegetable; storing the selection cards in a binder with dedicated sections for each food group; allowing the child to select one card from each group to build a personalized meal; providing a meal template page that visually separates each food group, with sections that allow the child to attach their selected cards using a secure method; and preparing a meal for the child based on the food selections shown on the cards.

A system for assisting children in selecting balanced meals, comprising: a collection of food item cards categorized by food groups, including dairy, protein, fruit, grain, and vegetable; a binder or container with distinct sections for each food group for storing the food item cards; a meal planning template with areas designated for each food group, to which the child can affix selected food cards; a method of securing the food cards to the corresponding areas of the meal template; and a step of preparing a meal based on the child's selections.

A method for encouraging children to make healthy meal choices, comprising the steps of: creating a variety of food cards, each card featuring a food item categorized into food groups of dairy, protein, fruit, grain, and vegetable; organizing the cards into a display format that segregates them by food group; instructing the child to select one food card from each food group to compose a balanced meal; providing a meal selection board with predefined slots for each food group, enabling the child to attach the selected food cards using a temporary fastening mechanism; and preparing the selected meal based on the choices reflected by the attached food cards.

A method for meal planning with children, comprising the steps of: preparing a plurality of food cards, each card corresponding to a food item and sorted by food group, including dairy, protein, fruit, grain, and vegetable; arranging the food cards in an interactive binder, where each food group is assigned a specific section; allowing the child to select one card from each food group section to build a complete meal; providing a structured menu page where the child attaches the selected food cards to designated sections using a hook and loop system; and receiving the completed menu and preparing the corresponding meal based on the selected food cards.

A method for child-directed meal assembly, comprising the steps of: providing a set of food option cards, each card representing a food item and categorized into one of five food groups: dairy, protein, fruit, grain, and vegetable; presenting the cards in a multi-sectioned binder or display unit, with each section dedicated to a particular food group; and facilitating the child's selection of one food card from each section to create a balanced meal; offering a meal selection template with sections for each food group, where the child places the chosen food cards using an attachment mechanism; and executing the meal preparation based on the food items represented on the selected food cards.

A method for structuring child meal choices, comprising the steps of: generating a plurality of food cards, each food card categorized by one of five food groups: dairy, protein, fruit, grain, and vegetable; sorting the food cards into a binder with labeled sections for each food group; directing the child to select one card from each section to create a balanced meal; providing a menu page with specific sections for each food group, where the child attaches the selected cards using a detachable connection; and preparing the meal based on the food cards the child has selected.

A method for involving children in balanced meal selection, comprising the steps of: assembling a set of food cards, each card representing a different food item categorized by food group, the food groups being dairy, protein, fruit, grain, and vegetable; organizing the food cards within a binder that separates them into sections based on food groups; enabling the child to select one food card from each food group section to compose a balanced meal; providing a meal card template with five distinct areas, corresponding to the five food groups, where the child affixes their selected food cards using a hook and loop attachment system; and receiving the completed meal template and preparing a meal based on the child's selected food cards.

A system for engaging children in balanced meal selection, comprising: a plurality of food cards, each card representing a food item and categorized into food groups including dairy, protein, fruit, grain, and vegetable; a food card organizer, comprising multiple sections, each section dedicated to one food group; a menu board with distinct sections for each food group, the board configured with attachment means allowing the child to affix selected food cards from the organizer; wherein the child selects a food card from each food group and affixes the selected food cards to the menu board, and the attached food cards are used to prepare a meal for the child based on the selected food items.

A meal planning system for children, comprising: a set of food cards, each card associated with a food item and categorized into food groups including dairy, protein, fruit, grain, and vegetable; a card storage binder having multiple labeled sections for each food group; a meal template with dedicated areas for each food group, configured with a hook and loop system for securing the food cards; wherein the child selects one card from each section of the binder, secures the cards to the corresponding areas on the meal template, and the caregiver prepares a meal based on the selected cards.

A child-directed meal selection system, comprising: a plurality of food selection cards, each card representing a food item grouped into food categories, including dairy, protein, fruit, grain, and vegetable; a binder with compartmentalized sections corresponding to the food categories for organizing the food cards; a menu sheet with separate attachment areas for each food category, configured to accept selected food cards via an attachment mechanism; wherein the child selects one food card from each category section and attaches it to the corresponding section of the menu sheet, and the attached food cards guide the caregiver in preparing a meal based on the selected food items.

A system for meal planning by a child, comprising: a set of food cards, each card corresponding to a specific food item and categorized into groups, the groups comprising dairy, protein, fruit, grain, and vegetable; a card organizer with labeled sections for storing the food cards by group; a meal page with distinct zones for each food group, the zones configured with attachment elements for securing selected food cards; wherein the child selects one food card from each group in the organizer, affixes the cards to the corresponding zones on the meal page, and the caregiver prepares a meal based on the food items depicted on the cards.

A child-friendly system for organizing and selecting meals, comprising: a collection of food item cards categorized by food group, including dairy, protein, fruit, grain, and vegetable; an organizer for housing the food item cards, comprising sections for each food group; a menu layout with designated sections for attaching selected food item cards, the layout including a secure attachment method; wherein the child chooses one card from each section of the organizer, affixes the selected cards to the menu layout, and the meal is prepared according to the food items represented by the selected cards.

A system for assisting children in selecting balanced meals, comprising: a set of food cards, each card representing a specific food item, categorized into food groups including dairy, protein, fruit, grain, and vegetable; a card holding apparatus with divided sections for organizing the food cards by food group; a meal card page with spaces corresponding to each food group, equipped with fastening means for securing food cards; wherein the child selects one food card from each section of the card holding apparatus, affixes the cards to the corresponding spaces on the meal card page, and the caregiver prepares the child's meal based on the selected food cards.

A system for child-involved meal planning, comprising: a plurality of food cards, each card categorized by food group and depicting a food item, the food groups including dairy, protein, fruit, grain, and vegetable; a binder with multiple compartments, each compartment dedicated to storing food cards from one food group; a menu board with areas corresponding to each food group, configured to receive and secure selected food cards; wherein the child selects a food card from each compartment of the binder, secures the cards to the appropriate areas on the menu board, and the attached cards dictate the meal preparation by the caregiver.

A system for facilitating child-driven meal creation, comprising: a collection of food cards, each representing a different food item and categorized into food groups, including dairy, protein, fruit, grain, and vegetable; an organizational structure with separate sections for each food group, designed to hold the food cards; a meal selection page with distinct regions for each food group, configured with an attachment mechanism for securing the selected food cards; wherein the child selects one food card from each section of the organizational structure, affixes the selected cards to the corresponding regions on the meal selection page, and a meal is prepared based on the selected food items.

A system for assisting children in constructing balanced meals, comprising: a plurality of food cards, each card corresponding to a food item categorized into food groups including dairy, protein, fruit, grain, and vegetable; a binder divided into multiple sections, each section corresponding to a food group for storing the food cards; a menu sheet with distinct attachment zones for each food group, the menu sheet equipped with a hook and loop fastening system for attaching selected food cards, wherein the child selects a food card from each section of the binder, affixes the selected cards to the corresponding attachment zones on the menu sheet, and the caregiver uses the cards to prepare a balanced meal.

A child-directed meal selection and preparation system, comprising: a plurality of food cards, each card categorized by food group, the food groups including dairy, protein, fruit, grain, and vegetable, and each card representing a food item; an organizer with separate sections for storing food cards by food group; a menu template page with distinct areas corresponding to the different food groups, configured to accept and secure selected food cards via an attachment mechanism; wherein the child selects one food card from each section of the organizer, attaches the selected cards to the corresponding areas on the menu template page, and the caregiver prepares a meal based on the food items represented on the selected cards.

A kit for facilitating meal selection by a child, comprising: a plurality of food cards, each card representing a specific food item and categorized into food groups comprising dairy, protein, fruit, grain, and vegetable; a binder configured with multiple sections, each section designated for organizing food cards from a specific food group; a menu template page, the page having distinct sections corresponding to each food group, and equipped with a hook and loop fastening system to attach the food cards; wherein the kit enables the child to select one food card from each section of the binder, attach the selected food cards to the corresponding areas on the menu template page, and the selected food cards are used by the caregiver to prepare a meal for the child based on the represented food items.

A kit for assisting a child in meal planning, comprising a set of food cards, each card corresponding to a food item and categorized by food group, the food groups including dairy, protein, fruit, grain, and vegetable; a storage organizer having multiple labeled sections, each section designated to hold food cards from a specific food group; a menu board with predefined attachment zones for each food group, the attachment zones configured with a hook and loop system for securing the selected food cards; wherein the child selects one food card from each section of the organizer, attaches the selected food cards to the corresponding zones on the menu board, and the caregiver prepares a meal based on the selected food items.

A meal selection kit for children, comprising: a plurality of food cards, each food card representing a food item and categorized into food groups, the food groups comprising dairy, protein, fruit, grain, and vegetable; a multi-sectioned binder configured to store the food cards, with each section corresponding to a specific food group; a meal selection page with distinct attachment areas for each food group, configured with an attachment mechanism for the food cards; wherein the child selects a food card from each section of the binder, attaches the selected food cards to the corresponding areas on the meal selection page, and the meal selection page is used by the caregiver to prepare a meal based on the food items represented by the food cards.

In further embodiments of the subject invention, the shape of the cards is selected from a group consisting of substantially circular, semi-circular, oval, elliptical, triangular, rectangular, pentagonal, trapezoidal, rhombus, hexagonal, heptagonal, and octagonal.

In additional embodiments of the subject invention, the body of the cards is composed of a fluid absorbing material.

In additional embodiments of the subject invention, the top surface of the cards comprises printed indicia selected from the group consisting of pictures, logos, colors, cartoon images, photographic images, game images, reflective materials, florescent materials, and advertisements.

In further embodiments of the subject invention, the cards are re-useable.

In embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

### BRIEF DESCRIPTION OF THE DRAWINGS

Advantages of the present invention will be apparent from the following detailed description of embodiments, which description should be considered in conjunction with the accompanying drawings, in which:

FIG. 1 Illustrates a first sheet containing fruit cards.

FIG. 2 Illustrates a second sheet containing protein cards.

FIG. 3 Illustrates a third sheet containing vegetable cards.

FIG. 4 Illustrates a fourth sheet containing dairy product cards.

FIG. 5 Illustrates a fifth sheet containing grain cards.

FIG. 6 Illustrates a sixth sheet containing blank spaces to receive cards within a specific food group available for a specific meal.

FIG. 7 Illustrates a seventh sheet containing blank spaces to receive five cards, one from each of the food groups.

### DETAILED DESCRIPTION OF THE INVENTION

While several variations of the present invention have been illustrated by way of example in particular embodiments, itis apparent that further embodiments could be developed within the spirit and scope of the present invention. However, it is to be expressly understood that such modifications and adaptations are within the spirit and scope of the present invention, and are inclusive, but not limited to the following appended claims as set forth.

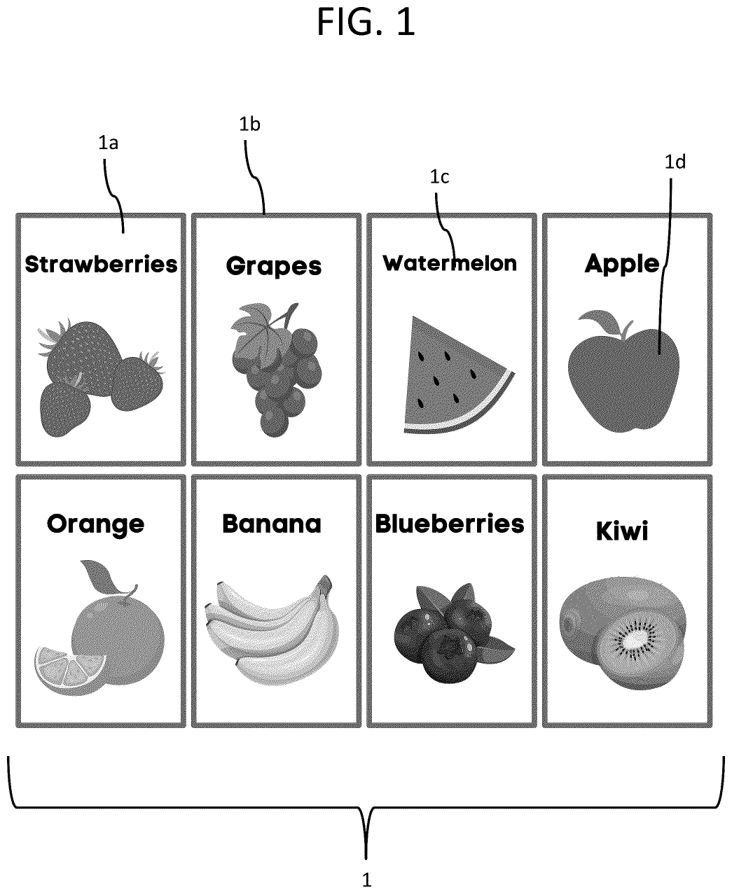

As illustrated in FIGS. 1-7, the subject invention is a method and system for children to choose a meal from a binder or folder of food options requiring the child to pick one food item from each of the five major food groups.

In the subject method and system, a child's caregiver takes inventory of their food options available in their refrigerator and pantry. The caregiver identifies a plurality of reusable cards for each food available and categorizes each card into each of the five food groups.

For example, as illustrated in FIG. 1, a first plurality of cards 1 may comprise available fruits for the meal. Each card 1a of this first plurality of cards 1 contains a first color border 1b, the name of the fruit 1c, and an image or drawing of the fruit 1d.

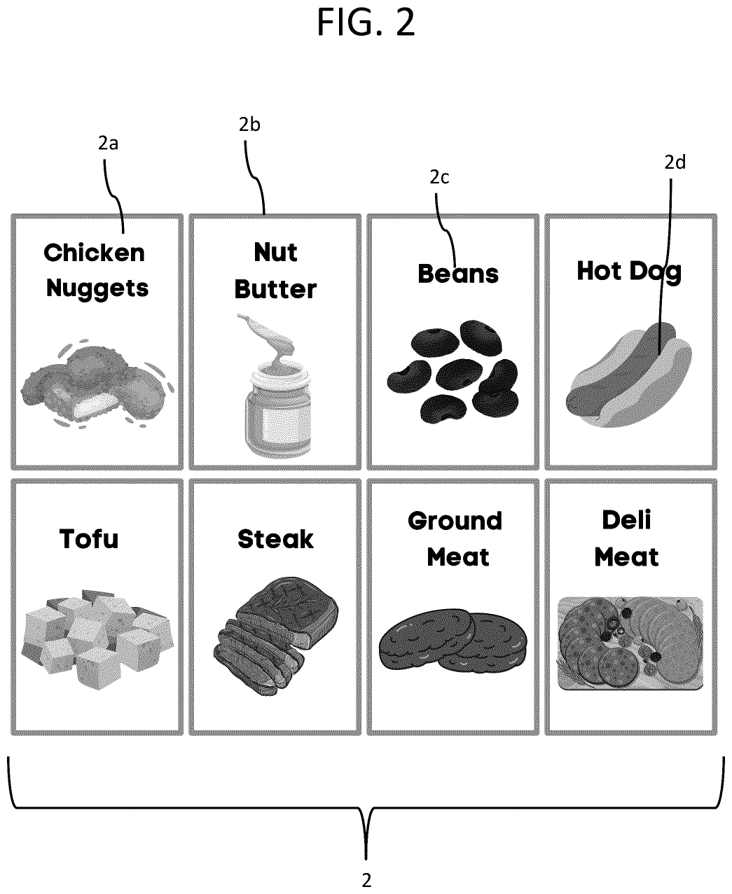

As illustrated in FIG. 2, a second plurality of cards 2 may comprise available proteins for the meal. Each card 2a of this second plurality of cards 2 contains a second color border 2b, the name of the protein 2c, and an image or drawing of the protein 2d.

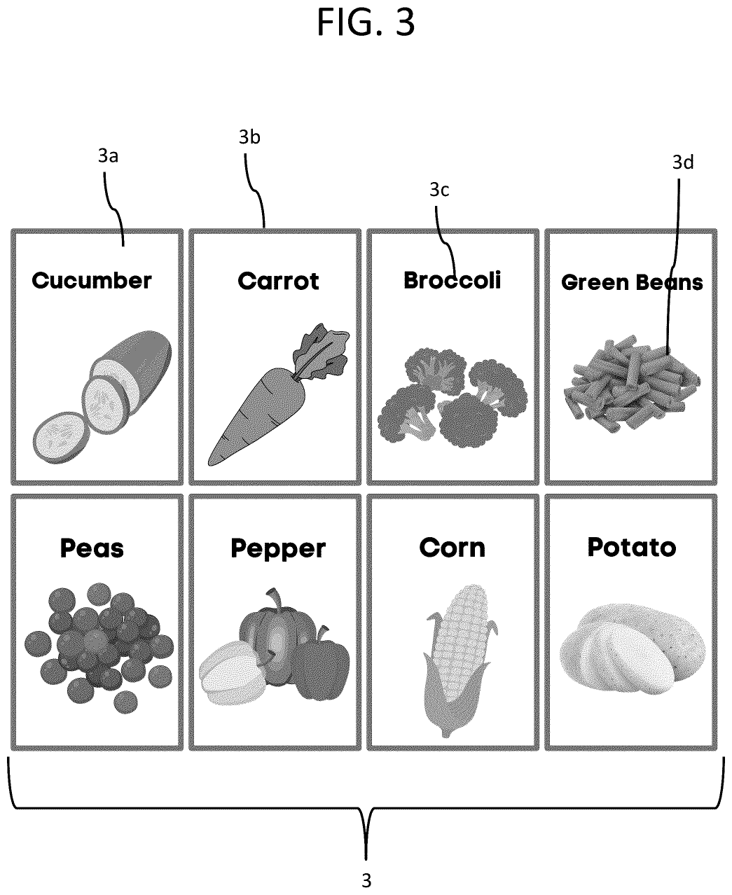

As illustrated in FIG. 3, a third plurality of cards 3 may comprise available vegetables for the meal. Each card 3a of this third plurality of cards 3 contains a third color border 3b, the name of the vegetable 3c, and an image or drawing of the vegetable 3d.

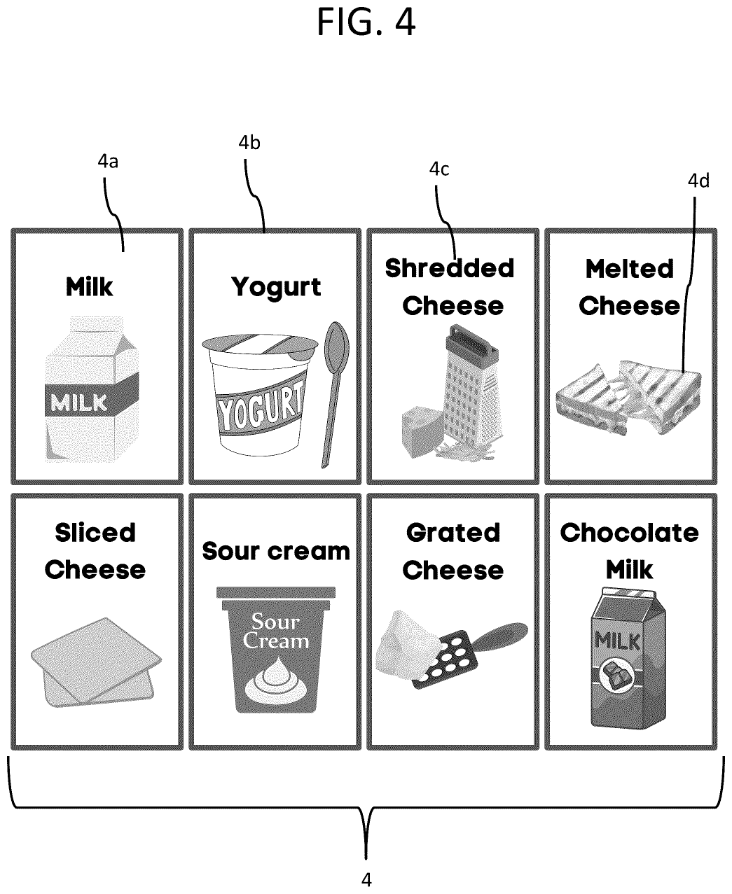

As illustrated in FIG. 4, a fourth plurality of cards 4 may comprise available dairy products for the meal. Each card 4a of this fourth plurality of cards 4 contains a fourth color border 4b, the name of the dairy product 4c, and an image or drawing of the dairy product 4d.

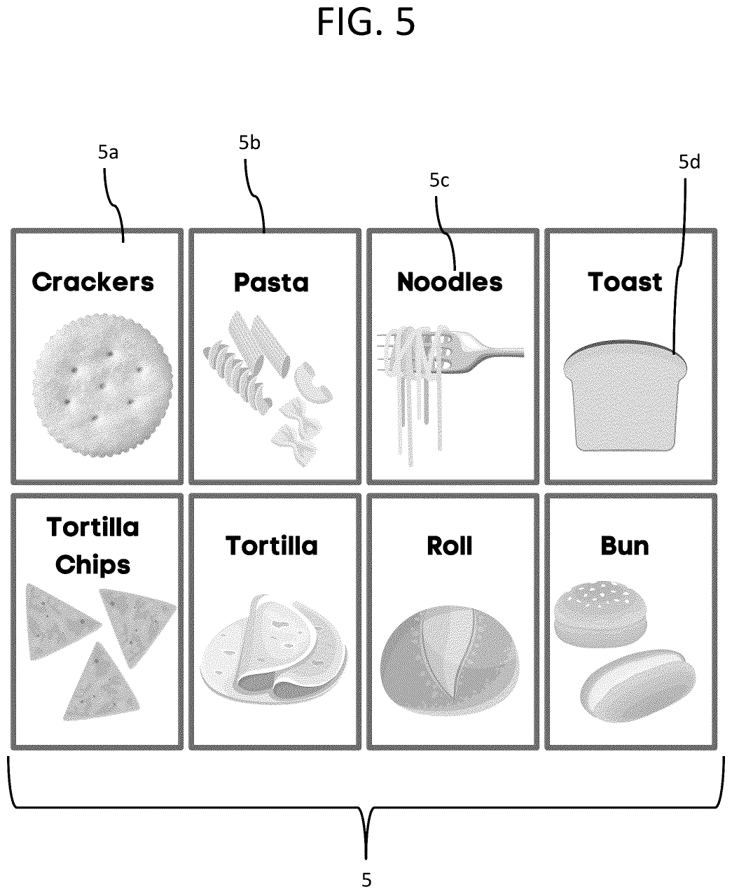

As illustrated in FIG. 5, a fifth plurality of cards 5 may comprise available grains for the meal. Each card 5a of this fifth plurality of cards 5 contains a fifth color border 5b, the name of the grain 5c, and an image or drawing of the grain 5d.

A sixth plurality of blank cards (not shown) may be included in the method and system. The sixth plurality of blank cards are pre-printed with one of the first, second, third, fourth, and fifth color borders 1b, 2b, 3b, 4b, or 5b. The sixth plurality of cards may each contain a writable surface. A caregiver may write and draw an available food not already shown in first, second, third, fourth, and fifth plurality of cards 1, 2, 3, 4, and 5 for the appropriate color border 1b (fruit), 2b (protein), 3b (vegetable), 4b (dairy product), or 5b (grain) for that available food.

In embodiments of the subject invention, the first, second, third, fourth, and fifth plurality of cards 1, 2, 3, 4, and 5 may be pre-printed. The first, second, third, fourth, and fifth plurality of cards 1, 2, 3, 4, and 5 may each contain a writable surface. The first, second, third, fourth, fifth, and sixth plurality of cards 1, 2, 3, 4, and 5 may each be substantially rectangular in shape. In other embodiments of the subject invention, the first, second, third, fourth, fifth, and sixth plurality of cards 1, 2, 3, 4, and 5 may each have a shape that is substantially circular, semi-circular, oval, elliptical, triangular, pentagonal, trapezoidal, rhombus, hexagonal, heptagonal, or octagonal.

The first, second, third, fourth, fifth, and sixth plurality of cards 1, 2, 3, 4, and 5 may each be composed of flexible, substantially flat and waterproof materials, such as translucent plastic, acrylic, vinyl polymers, or soft plastic materials. In other embodiments of the subject invention, the first, second, third, fourth, fifth, and sixth plurality of cards 1, 2, 3, 4, and 5 may each contain other printed indicia, such indicia may include, but is not limited to: pictures, logos, colors, cartoon images, photographic images, game images, reflective materials, florescent materials, or advertisements.

The first, second, third, fourth, and fifth color borders 1b, 2b, 3b, 4b, or 5b may be any five separate color combinations. These colors may include, but are not limited to red, blue, yellow, green, orange, purple, red-orange, yellow-orange, yellow-green, blue-green, blue-purple, red-purple, black, white, gray, pink, magenta, cyan, turquoise, teal, lime green, violet, lavender, indigo, maroon, burgundy, beige, tan, brown, ivory, olive green, mustard yellow, peach, coral, gold, silver, copper, bronze, navy blue, sky blue, mint green, sea green, charcoal, salmon, rust, plum, chocolate, crimson, amber, and chartreuse.

To implement the method and system, caregivers build a binder filled with available food options from each of the main food groups: fruit, protein, vegetables, dairy products, and grains—represented by the first, second, third, fourth, and fifth plurality of cards 1, 2, 3, 4, and 5.

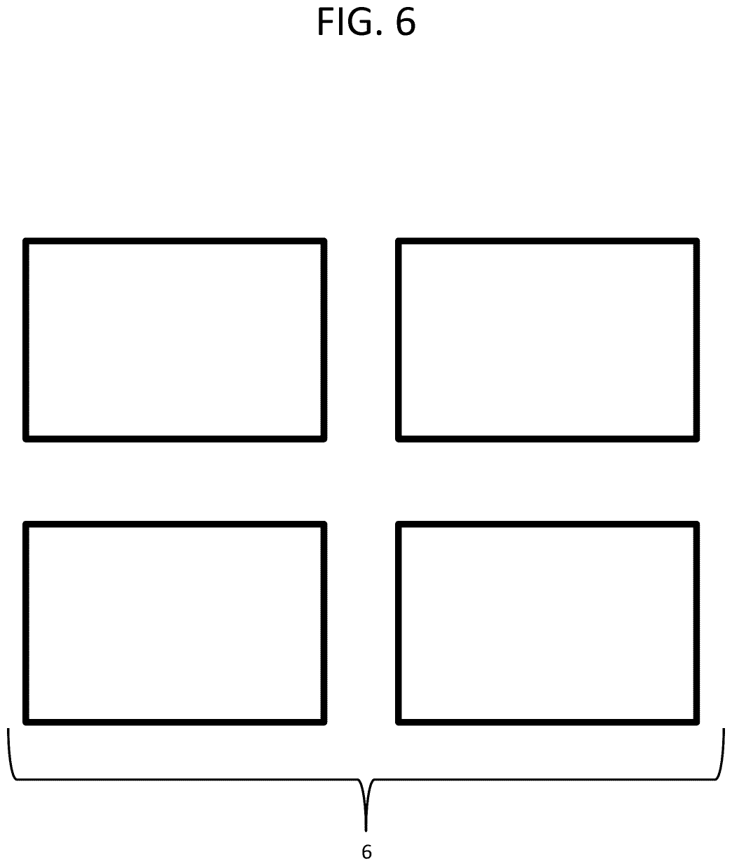

As illustrated in FIG. 6, the binder contains five or more blank sheets 6, which each sheet 6 comprising multiple open spaces. The open spaces on each sheet 6 have the same colored border that corresponds to the colored borders of the first, second, third, fourth, and fifth plurality of cards 1, 2, 3, 4, and 5.

The first, second, third, fourth, and fifth plurality of cards 1, 2, 3, 4, and 5 are re-usably attached to the corresponding blank sheets 6 with a re-useable attachment, such as a hook and loop fastener (not shown). The food cards represent items available in the caregiver's pantry or fridge. By rotating these cards, caregivers can introduce new foods into the child's diet without overwhelming them. This also helps avoid disputes over unavailable ingredients, as the choices are limited to what the caregiver has on hand.

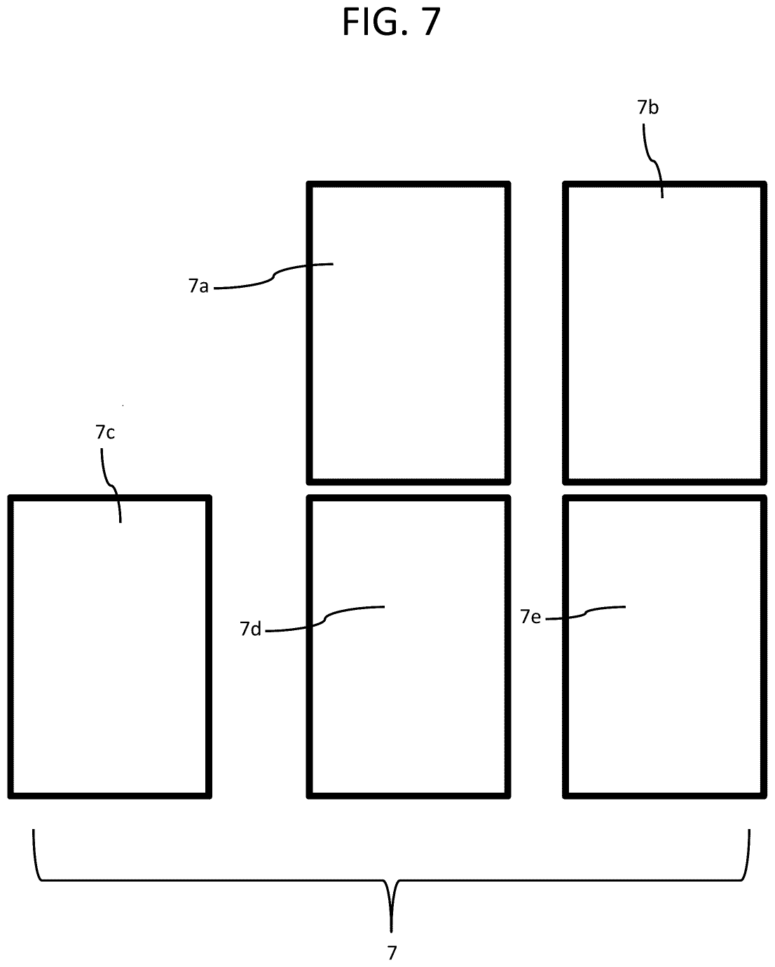

As illustrated in FIG. 7, the binder also contains one or more blank sheets 7, which each comprise five open spaces 7a, 7b, 7c, 7d, and 7e. The five open spaces 7a, 7b, 7c, 7d, and 7e have colored borders that correspond to the colored borders of the first, second, third, fourth, and fifth plurality of cards 1, 2, 3, 4, and 5, with 7a and being identical color with border 1b; with 7b being an identical color with border 2b; 7c being an identical color with border 3b; 7d being an identical color with border 4b; and 7e being an identical color with border 5b.

In order to make a meal selection, a child is presented the binder. The first, second, third, fourth, and fifth plurality of cards 1, 2, 3, 4, and 5 are each attached to separate corresponding blank sheets 6 within the binder.

For each meal selection, the child selects one card from each corresponding blank sheets 6 from the first, second, third, fourth, and fifth plurality of cards 1, 2, 3, 4, and 5 and places the selected five cards into the corresponding five open spaces 7a, 7b, 7c, 7d, and 7e on blank sheet 7. The five open spaces 7a, 7b, 7c, 7d, and 7e on blank sheet 7 will each contain a hook and loop connection in the middle of each colored space to receive and removably hold the five selected cards.

For example, the child will review the available Fruit sheet (from FIG. 1) and select one of the plurality of fruit cards 1a and place the selected fruit card 1a into open space 7a on blank sheet 7. The child will then review the available protein sheet (from FIG. 2) and select one of the plurality of protein cards 2a and place the selected protein card 2a into open space 7b on blank sheet 7. The child will then review the available protein sheet (from FIG. 3) and select one of the plurality of vegetable cards 3a and place the selected vegetable card 3a into open space 7c on blank sheet 7. The child will then review the available protein sheet (from FIG. 4) and select one of the plurality of dairy product cards 4a and place the selected dairy product card 4a into open space 7d on blank sheet 7. The child will then review the available protein sheet (from FIG. 5) and select one of the plurality of grain cards 5a and place the selected grain card 5a into open space 7e on blank sheet 7.

Once the child has placed five cards onto blank sheet 7, the selected menu is handed to the caregiver. The caregiver will then prepare the plate of food that includes each of the five food items from the five food groups that the child has selected. The child will then eat the balanced meal that they selected.

This method and system takes the struggle out of mealtime with children by giving them control over what they eat, rather than forcing them into predetermined meal choices. Allowing children to pick their own meals can help them learn to eat a balanced diet by choosing one food from each food group. Even if they don't eat all the food on their plate, exposure to a variety of foods increases the likelihood that they will try new things. Since the child is in control, they are more likely to eat the food they select.

This process not only encourages the child to feel involved in meal planning but also reduces conflict over food. By giving the child, a say in what they eat, caregivers can eliminate the power struggles that often accompany mealtime. The child feels empowered by their ability to choose, and this control fosters a sense of independence while simultaneously guiding them toward balanced eating habits. The caregiver's role is also simplified. With a pre-prepared binder of available food options, they can avoid the frustration of children asking for meals that cannot be made due to missing ingredients. The rotating binder ensures that new foods can be introduced at a comfortable pace, and old favorites can be revisited when desired. Plus, because the menu is built from existing food options, there's no need for last-minute grocery runs.

The interactive nature of this method makes mealtime more enjoyable for children. Instead of simply being handed a plate of food, they actively participate in the process. This participation helps children become more familiar with different foods, flavors, and textures, making it easier for them to build a diverse palate over time. For picky eaters, this gradual exposure can help them grow more comfortable with trying new foods.

This system also teaches children the basics of nutrition. By picking one item from each food group, children begin to understand the concept of balanced eating. Over time, they learn how each food group contributes to a healthy diet, which can set the foundation for lifelong healthy eating habits. It also fosters a greater sense of responsibility, as children see the direct results of their choices when their meal is prepared and served.

Furthermore, caregivers can use the binder to adjust to a child's changing preferences and dietary needs. If a child develops a dislike for a certain food, it can easily be swapped out for something else. The flexibility of the binder allows caregivers to cater to specific dietary restrictions or preferences without sacrificing variety or balance.

The structured approach to meal selection also helps reduce food waste. When children choose their own meals, they are more likely to eat everything on their plate. Since they are involved in the selection process, there is less chance of them rejecting the meal outright, and they can avoid items they know they won't eat.

Finally, this method fosters a collaborative atmosphere between the child and caregiver. Instead of mealtime being a point of contention, it becomes a shared activity. Both parties have a role in the meal, making the experience more cooperative and enjoyable.

What is claimed is:

1. A method for facilitating meal selection by a child, comprising the steps of:
(a) providing a plurality of food cards, each food card corresponding to a food item and categorized by food group, the food groups comprising dairy, protein, fruit, grain, and vegetable;
(b) assembling the food cards into a binder, the binder having separate sections for each food group;
(c) enabling a child to select one food card from each section of the binder, the selected food cards representing the child's choice for a meal comprising at least one food item from each food group;
(d) providing a menu page, the menu page having distinct sections corresponding to each food group, wherein the child attaches the selected food card to the corresponding section of the menu page using a hook and loop fastening system; and receiving the completed menu page from the child and preparing a meal for the child based on the food items represented by the selected food cards.

2. The method of claim 1, further comprising the step of rotating the available food cards in the binder to introduce new food options periodically.

3. The method of claim 1, wherein each food card includes a picture of the food item in addition to the name of the food item.

4. The method of claim 1, wherein the binder is customizable by the caregiver to add or remove food cards based on the food items available.

5. The method of claim 1, further comprising color-coding the food cards based on their respective food groups.

6. The method of claim 1, further comprising the step of labeling the food cards with nutritional information about the food items.

7. The method of claim 1, wherein the hook and loop fastening system includes a visual indicator for aligning the food cards with the correct section of the menu page.

8. The method of claim 1, wherein the menu page includes five different colored sections, each color corresponding to a different food group.

9. The method of claim 1, further comprising reusing the menu page and food cards for subsequent meal selections.

10. The method of claim 1, further comprising a set of pre-printed food cards that the caregiver can replenish or replace over time.

11. A system for facilitating meal selection by a child, comprising: a plurality of food cards, each food card corresponding to a specific food item and categorized by food group, wherein the food groups comprise dairy, protein, fruit, grain, and vegetable; a binder configured to hold the food cards, the binder having multiple sections, each section dedicated to a specific food group; a menu page configured to allow the child to attach a selected food card from each food group section to the corresponding section of the menu page, wherein the menu page comprises distinct areas for each food group and includes a hook and loop fastening system for attaching the selected food cards; wherein the child selects one food card from each section of the binder, attaches the selected food cards to the corresponding areas of the menu page, and the selected food cards on the menu page are used by the caregiver to prepare a meal for the child based on the food items represented by the food cards.

12. The system of claim 11, further comprising rotating the available food cards in the binder to introduce new food options periodically.

13. The system of claim 11, wherein each food card includes a picture of the food item in addition to the name of the food item.

14. The system of claim 11, wherein the binder is customizable by the caregiver to add or remove food cards based on the food items available.

15. The system of claim 11, further comprising color-coding the food cards based on their respective food groups.

16. The system of claim 11, further comprising labeling the food cards with nutritional information about the food items.

17. The system of claim 11, wherein the hook and loop fastening system includes a visual indicator for aligning the food cards with the correct section of the menu page.

18. The system of claim 11, wherein the menu page includes five different colored sections, each color corresponding to a different food group.

19. The system of claim 11, further comprising reusing the menu page and food cards for subsequent meal selections.

20. The system of claim 11, further comprising a set of pre-printed food cards that the caregiver can replenish or replace over time.
